(19) United States
(12) Patent Application Publication
(10) Pub. No.: US 2009/0106670 A1
(43) Pub. Date: Apr. 23, 2009

(54) SYSTEMS AND METHODS FOR PROVIDING SERVICES IN A VIRTUAL ENVIRONMENT

(76) Inventors: Philipp Christian Berndt, Berlin (DE); Marc Werner Fleischmann, Foster City, CA (US); Burckhardt Ruben Joseph Jason Bonello, Berlin (DE); Matthias Welk, Berlin (DE)

Correspondence Address: HUGH P. GORTLER, 23 ARRIVO DRIVE, MISSION VIEJO, CA, 92692, US

(21) Appl. No.: 11/875,836

(22) Filed: Oct. 20, 2007

(51) Int. Cl. G06F 3/048

(52) U.S. Cl. 715/757

(57) ABSTRACT

A network-accessible virtual environment includes objects that represent users of a service. The users are allowed to control their representative objects in the virtual environment to interact with other users represented in the virtual environment and also to become voice-enabled. Those users who are voice-enabled can speak with other voice-enabled users via phones.

### BRIEF DESCRIPTION OF THE DRAWINGS

FIG. 1 is an illustration of a method in accordance with an embodiment of the present invention.

FIG. 2 is an illustration of a virtual environment in accordance with an embodiment of the present invention.

FIG. 3 is an illustration of audio ranges in accordance with an embodiment of the present invention.

FIG. 4 is an illustration of two avatars facing each other.

FIG. 5 is an illustration of a system in accordance with an embodiment of the present invention.

FIG. 6 is an illustration of a method in accordance with an embodiment of the present invention.

FIG. 7 is an illustration of activities facilitated by a service provider in accordance with an embodiment of the present invention.

FIG. 8 is an illustration of services provided by a service provider in accordance with an embodiment of the present invention.

### DETAILED DESCRIPTION

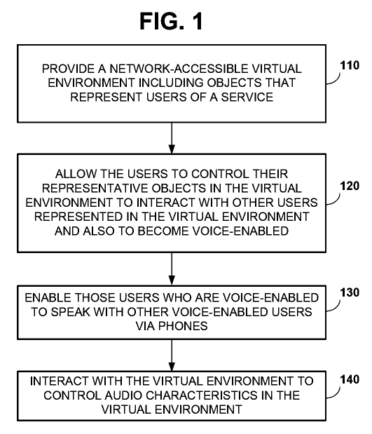

Reference is made to FIG. 1, which illustrates a method of providing a service that allows for personal interaction between users. The method includes providing a network-accessible virtual environment including objects that represent users of the service (block 110), allowing the users to control their representative objects in the virtual environment to personally interact with other users represented in the virtual environment and also to become voice-enabled (block 120), and enabling those users who are voice-enabled to speak with other voice-enabled users via phones (block 130).

Phones are not limited to any particular type. Examples of phones include PSTN phones (e.g., touch-tone phones) and VoIP phones including soft phones.

When a user becomes voice-enabled, that user can speak with other voice-enabled users who are represented in the virtual environment. As a first example of becoming voice-enabled, a user of a traditional phone can become voice-enabled by placing a call to the service provider. As a second example, a user can become voice-enabled by receiving a call from the service provider.

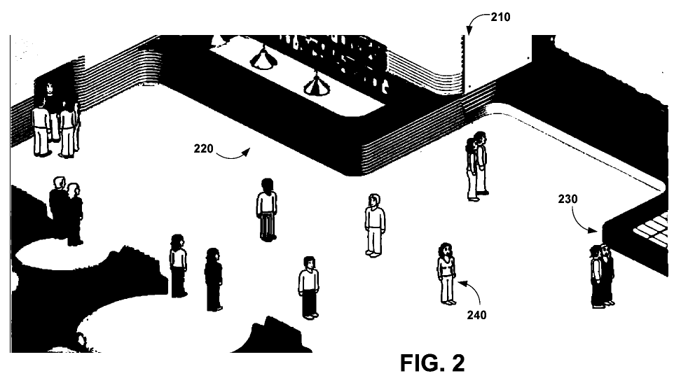

A virtual environment includes a scene and sounds. A virtual environment is not limited to any particular type of scene or sounds. As a first example, a virtual environment includes a beach scene with blue water, white sand and blue sky. In addition, the virtual environment includes an audio representation of a beach (e.g., waves crashing against the shore, sea gulls cries). As a second example, a virtual environment includes a club scene, complete with bar, dance floor, and dance music (an exemplary bar scene 210 is depicted in FIG. 2). As a third example, a virtual environment includes a park with a microphone and loudspeakers, where sounds picked up by the microphone are played over the speakers.

A virtual environment includes objects. An object in a virtual environment has properties that allow a user to perform certain actions on them (e.g., sit on, move, and open). An object (e.g., a Flash® object) in a virtual environment may obey certain specifications (e.g., an API).

At least some of the objects represent users of the service. These user representative objects could be images, avatars, live video, recorded sound samples, name tags, logos, user profiles, etc. In the case of avatars, live video or photos could be projected on them. In some situations, a user cannot see his own representative object, but rather sees the virtual environment as his representative object would see it (that is, from a first person perspective).

Avatars and other user representative objects have states that can be changed. For instance, an avatar has states such as location, mood and orientation. The avatar can be commanded to walk or run from its current location (current state) to a new location (new state).

Other objects in the virtual environment also have states that can be changed. As a first example, a volleyball is represented by an object. Hitting the volleyball causes the volleyball to follow a path towards a new location. As a second example, a balloon is represented by an object. The balloon may start uninflated (e.g., a current state) and expand gradually to a fully inflated size (new state). As a third example, an object represents a jukebox having methods (actions) such as play/stop/pause, and properties such as volume, song list, and song selection. As a fourth example, an object represents an Internet object, such as a uniform resource identifier (URI) (e.g., a web address). Clicking on the Internet object opens an Internet connection, for example, to access the remote state of the Internet object.

Different objects can provide different sounds. The sounds of a jukebox might include different songs in a playlist. The sounds of an avatar might include walking sounds. Yet even the walking sounds of different avatars might be different. For instance, the walking sound of an avatar wearing high heels might be different than that of one wearing flip-flop sandals. Walking sounds may also change subject to the terrain. For instance the walking sound on parquet flooring may be different than that on snow.

The virtual environment is network-accessible. For example, the virtual environment may be accessed via the Internet or a local area network (LAN).

The users may control the objects in a virtual environment with client devices. A client device refers to a device that can run a client and provide a graphical interface. One example of a client is a Flash® client. Client devices are not limited to any particular type. Examples of client devices include, but are not limited to computers, tablet PCs, gaming consoles, televisions with set-top boxes, certain cell phones, and personal digital assistants. Another example of a client device is a device running a textual user interface, such as a Telnet program. Yet another example is a mobile phone such as an iPhone running a chat-client such as Google-Talk.

Each client causes its client device to display a virtual environment, including the objects within. A client device generates commands, and those objects are controlled in response to the commands. By moving his representative object around a virtual environment, a user can experience the sights and sounds that the virtual environment offers.

By moving his representative object around a virtual environment, a user can interact with other users. For instance, a voice-enabled user may interact with another voice-enabled user by moving into the other user's audio range. An audio range limits the distance that sound can be received and/or broadcasted. The audio ranges facilitate multiple conversations in a single virtual environment.

In general, interaction is a function of “closeness” between two users. Closeness may be measured in terms of distance between two representative objects in a virtual environment. However, closeness is not so limited. Another topology metric may be used to measure closeness. For example, closeness could be Euclidean distance between two representative objects. The distance may even be a real distance between the user and another user or real life object. For instance, the real distance might be the distance between a user in New York City and another user in Berlin. Another topology metric may measure closeness as the distance (in hyperlinks) between web pages currently being viewed by two users. Yet another topology metric may measure closeness as the distance (e.g., pixel distance) between two coordinates on a web page (for example, the distance between two coordinates that are pointed at by two users with their mouse pointers).

A virtual environment could overlap real space. For example, a scene of a real place is displayed (e.g., a map of a city or country, a room). Locations of people in that real place can be determined, for example with GPS-equipped phones. The users whose real locations are known are represented virtually by avatars in their respective locations in the virtual environment. Or, the place might be real, but the locations are not. Instead, a user's avatar wanders to different places to meet different people.

A user can also become voice-enabled via a client device. As a first example, a client device initiates a phone connection by pressing a “Call me” button upon which the service provider calls the user's phone. As a second example, a client device could command a co-installed VoIP soft-phone (e.g. via XML sockets) to establish a VoIP connection with the service provider. As a third example, an integrated client/phone such as a graphical Flash® client could have built-in VoIP capabilities. As a fourth example, a mobile phone could run a GUI+voice application. As a fifth example, a blind user could use a textual (telnet/Braille) client to issue a text command upon which the service provider calls the user's phone.

If one user wants to talk to some others who are not in the virtual environment at that time, that user could request the service provider to send invitations (e.g., via email, instant messaging or SMS messages) to those users. In case of email or instant messaging, a recipient may simply click on a link in the message to load the client and participate in a conversation.

Thus, a user can utilize both a client device and a phone to interact with other users. The client device is used to interact with the virtual environment and help the user meet other users. The phone is used to speak with at least one other user. However, some phones (e.g., certain VoIP phones) may also have the functionality of a client device.

Reference is made to FIG. 2, which depicts an exemplary virtual environment including a club scene 210. The club scene 210 includes a bar 220, and dance floor 230. A user is represented by an avatar 240. Other users in the club scene 210 are represented by other avatars. An avatar could be moved from its current location to a new location by clicking on the new location in the virtual environment, pressing a key on a keyboard, entering text, entering a voice command, etc.

Dance music is projected from speakers (not shown) near the dance floor 230. As the user's avatar 240 approaches the speakers, the music heard by the user becomes louder. The music is loudest when the user's avatar 240 is in front of the speakers. As the user's avatar 240 is moved away from the speakers, the music becomes softer. If the user's avatar 240 is moved to the bar 220, the user hears background conversation (which might be actual conversations between other users at the bar 220). The user might hear other background sounds at the bar 220, such as a bartender washing glasses or mixing drinks. The user might hear other sounds of the virtual environment as well.

The user might not know any of the other users represented in the club scene 210. However, the user can interact with other users by becoming voice enabled, and becoming close to that other user's avatar. Users can use their phones to speak with each other (each phone makes a connection with the service provider, and the service provider completes the connection between the phones). The user can command his avatar 240 to leave a conversation, wander around the club scene 210, and approach other avatars so as to listen in on other conversations and speak with other users. The user can listen in on one or more conversations simultaneously. Even while engaged in one conversation, a user has the ability to listen in on other conversations, and seamlessly leave the one conversation and join another conversation. A user could even be involved in a chain of conversations (e.g., a line of people where person C hears B and D, and person D hears C and E, and so on).

Returning to FIG. 1, the user interacts with the virtual environment to control audio characteristics in the virtual environment (block 140). For example, the volume of sound data can be controlled. In some embodiments, volume of sound between one user and another is a function of distance between and relative orientation of their representative objects. In some embodiments, the representative objects also have audio ranges.

Audio characteristics other than volume may also be controlled according to how users interact with the virtual environment. For example, filters can be applied to sound data to add reverb, distort sounds, etc. An object's audio characteristics might be changed by applying filters (e.g. reverb, room acoustics) to the object's sound data. Examples of changing audio characteristics include the following. As an avatar walks from a carpeted room into a stone hall, a parameter of a reverb filter is adjusted to add more reverb to the user's voice and avatar's footsteps. As an avatar walks into a metallic chamber, a parameter of an effect filter is adjusted so the user's voice and avatar's footsteps are distorted to sound metallic. When an avatar speaks into a virtual microphone or virtual telephone, a filter (e.g. band pass filter) is applied to the avatar's sound data so the user's voice sound as if it's coming from a loudspeaker system or telephone.

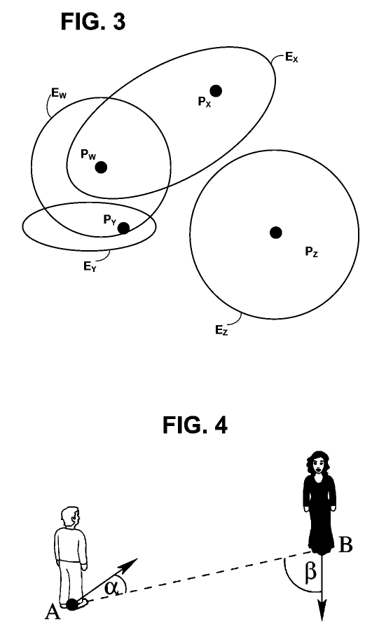

Reference is now made to FIG. 3, which illustrates one way in which the volume of sound data can be controlled. A user's representative object is at location P_{W} and three other objects are at locations P_{X}, P_{Y} and P_{Z}.

Let MIX_{W} be the sound heard by the user represented at location P_{W}. In a simple sound model, MIX_{W} may be expressed as

MIX_{W}=aV_{X}+bV_{Y}+cV_{Z}

where V_{X}, V_{Y}, and V_{Z} are sound data from the objects at locations P_{X}, P_{Y} and P_{Z}, and where a, b and c are sound coefficients. In this simple model, the volume of sound data V_{X} is adjusted by coefficient a, the volume of sound data V_{Y} is adjusted by coefficient b, and the volume of sound data V_{Z} is adjusted by coefficient c.

In some embodiments, the value of each coefficient may be inversely proportional to the distance between the sound-generating object (the sound source) and the user's representative object at location P_{W}. As such, sound gets louder as the user's object and the sound source move closer together, and sound gets softer as they move farther apart.

Each object may have an audio range. The audio range is used to determine whether sound is cut off. The audio ranges of the objects at locations P_{W} and P_{Z} are indicated by circles E_{W} and E_{Z}. Audio ranges of the objects at locations P_{X} and P_{Y} are indicated by ellipses E_{X} and E_{Y}. The elliptical shape of an audio range indicates that the sound from its audio source is directional or asymmetric. The circular shape indicates sound that the sound is omni-directional (that is, projected equally in all directions).

In some embodiments, coefficient c=0 when location P_{Z} is outside the range E_{W}, and coefficients a=1 and b=1 when locations P_{X} and P_{Y} are within the range E_{W}. In other embodiments, a coefficient may vary between 0 and 1. For instance, a coefficient might equal a value of zero at the perimeter of the range, a value of one at the location of the user's representative object, and a fractional value therebetween.

In some embodiments, a sound will fade as the distance between the sound source and the user's representative object increases, and the sound will be cut off as soon as the sound source is out of range.

The audio range may be a receiving range or a broadcasting range. If a receiving range, a user will hear other sources within that range. Thus, the user will hear sound from other users whose representative objects are at locations P_{X} and P_{Y}, since the audio ranges E_{X} and E_{Y} intersect the range E_{W}. The user will not hear a user whose representative object is at location P_{Z}, since the audio range E_{W} does not intersect the range E_{Z}.

If the audio range is a broadcasting range, a user hears those sources in whose broadcasting range he is. Thus, the user will hear sound from the object at location P_{X}, since location P_{W} is within the ellipse E_{X}. The user will not hear sounds from the objects at locations P_{Y} and P_{Z}, since the location P_{W} is outside of the ellipses E_{Y} and E_{Z}.

In some embodiments, the user's audio range is fixed. In other embodiments, the user's audio range can be dynamically adjusted. For instance, the audio range can be reduced if a virtual environment becomes too crowded. Some embodiments might have a function that allows for private conversations. That function may be realized by reducing the audio range (e.g. to a whisper) or by forming a disconnected “sound bubble.” Some embodiments might have a “do not disturb” function, which may be realized by reducing the audio range to zero.

Different audio ranges may have different shapes and sizes, different attenuation functions, directionality/orientation, state dependent attenuation, etc.

As for objects representing users, avatars offer certain advantages over other types of objects. Avatars allow certain types of interactions between users.

One type of interaction is realized by the orientation of two avatars. For instance, the volume of sound between two users may be a function of relative orientation of their two avatars. Two users whose avatars are facing each other will hear each other better than they would if one avatar is facing away from the other, and much better than if both avatars are facing away from each other.

Reference is made to FIG. 4, which shows two avatars A and B facing in the directions of the arrows. The avatars A and B are facing each other directly if angles α and β between the avatars' attitude and their connecting line AB equal zero. Assume avatar A is speaking and avatar B is listening. The value of the attenuation function can vary differently for changes to α and β. In this case the attenuation is asymmetrical. One advantage of orientation-based attenuation is allowing a user to take part in one conversation, while casually hearing other conversations.

The attenuation may also be a function of the distance between avatars A and B. The distance between avatars A and B may be taken along line AB.

Thus, another sound model may be based on direction, orientation, distance and states of the objects associated with the sound sources and sound drains. As an example of a state, the volume or audio range of sound data might be reduced if an object is in a whisper mode, or the volume or audio range might be increased if the object is in yell mode. The volume heard by an object or its receiving range could be reduced if that object is in a do-not-disturb mode. A sound model may also consider others factors that influence the volume of sound data. For instance a user's broadcasting audio range could be increased when he is detected to be shouting and reduced when he is detected to be whispering.

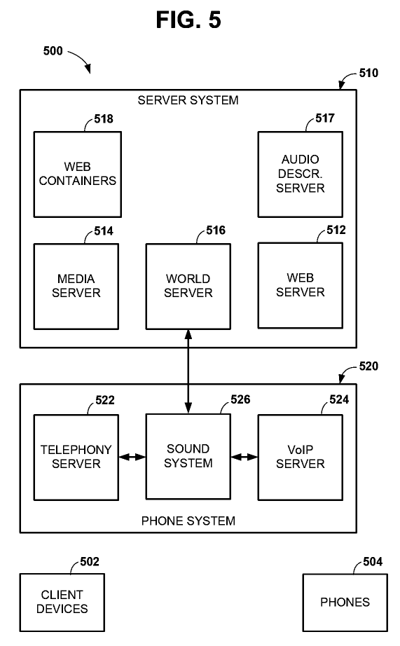

Reference is made to FIG. 5, which illustrates an exemplary web-based system 500. The communications system 500 includes a VE server system 510. The “VE” refers to virtual environment.

Client devices are referenced by numeral 502. Phones are referenced by numeral 504.

The VE server system 510 hosts a website, which includes a collection of web pages, images, videos and other digital assets. The VE server system 510 includes one or more web servers 512 for serving web pages, and one or more media servers 514 for storing video, images, and other digital assets.

One or more of the web pages embed client files. Files for a Flash® client, for instance, are made up of one or more separate Flash® objects (.swf files) that are served by the web server 512 (some of which can be loaded dynamically when they are needed).

A client is not limited to a Flash® client. Other browser-based clients include, without limitation, Java™ applets, Microsoft® Silverlight™ clients, .NET applets, Shockwave® clients, scripts such as JavaScript, etc. A downloadable, installable program could even be used.

Using a web browser, a client device 502 downloads web pages from a web server 512 and then downloads the embedded client files from a web server 512. The client files are loaded into the client device, and the client is started. The client starts running the client files and loads the remaining parts of the client files (if any) from a web server 512.

An entire client or a portion thereof may be provided to a client device. Consider the example of a Flash® client including a Flash® player and one or more Flash® objects. The Flash® player is already installed on a client device. When .swf files are sent to and loaded into the Flash® player, the Flash® player causes the client device to display a virtual environment. The client also accepts inputs (e.g., keyboard inputs, mouse inputs) that command a user's representative object to move about and experience the virtual environment.

The server system 510 also includes one or more world servers 516. The “world” refers to a set of representations of the virtual environment provided by the server system 510. When a client starts running, it opens a connection with a world server 516. The server system 510 selects a description of a virtual environment and sends the selected description to the client. The selected description contains links to graphics and other media for the virtual environment. The description also contains coordinates and appearances of all objects in the virtual environment. The client loads media (e.g., images) from a media server 514, and projects the images (e.g., in isometric, 3-D).

The client displays objects in the virtual environment. Some of these objects are user representative objects such as avatars. The animated views of an object could comprise pre-rendered images or just-in-time rendered 3D-Models and textures, that is, objects could be loaded as individual Shockwave® objects, parameterized generic Shockwave® objects, images, movies, 3D-models optionally including textures, and animations. Users could have unique/personal avatars or share generic avatars.

When a client device 502 wants an object to move to a new location in the virtual environment, its client determines the coordinates of the new location and a desired time to start moving the object, and generates a request. The request is sent to the world server 516.

The world server 516 receives a request and updates the data structure representing the “world.” The world server 516 manages each object state in one or more virtual environments, and updates the states that change. Examples of states include avatar state, objects they're carrying, user state (account, permissions, rights, audio range, etc.), and call management. When a user commands an object in a virtual environment to a new state, the world server 516 commands all clients represented in the virtual environment to transition the state of that object, so client devices display the object at roughly the same state at roughly the same time. The world server 516 may also perform collision detection and avoidance, path finding, and ensure, in general, consistent (e.g. physically correct) behavior.

The world server 516 can also manage objects that transition gradually or abruptly. When a client device commands an object to transition to a new state, the world server 516 receives the command and generates an event that causes all of the clients to show the object at the new state at a specified time.

The world server 516 generates coefficients for the sound model. For example, the world server 516 keeps track of distances between objects, and generates the coefficients as a function of the distance between the objects. The world server 516 supplies the coefficients to a phone system 520, which applies the coefficients to the audio data.

The phone system 520 establishes phone connections with traditional phones (landline and cellular), VoIP phones, and other phones 504. Some embodiments of the phone system 520 may include one or more telephony servers 522 for establishing calls with phones via a public switched telephone network (PSTN). For instance, a telephony server 522 may include PBX or ISDN cards for making connections for users with traditional telephones (e.g., touch-tone phones) and digital phones. The telephony server 522 may include mobile network or analog network connectors. These cards act as the terminal side of a PBX or ISDN line and, in cooperation with associated software, perform all low-level signaling for establishing phone connections. Events (e.g. ringing, connect, disconnect) and audio data in chunks (of e.g. 100 ms) are passed from a card to a sound system 526. The sound system 526, among other things, mixes the audio between users in a teleconference, mixes in any external sounds (e.g., the sound of a jukebox, a person walking, etc) and passes the mixed (drain) chunks back to the card and, therefore, to a user.

Some embodiments of the phone system 520 may include one or more VoIP servers 524 for establishing connections with users who call in with VoIP phones. In this case, a client (e.g., the client 160 of FIG. 1) may contain functionality by which it tries to connect to a VoIP soft-phone phone using, for example, an xml-socket connection. If the client detects the VoIP phone, it enables VoIP functionality for the user. The user can then (e.g., by the click of a button) cause the client to establish a connection by issuing a CALL command via the socket to the VoIP phone which calls a VoIP server 524 while including information necessary to authenticate the VoIP connection.

Some embodiments of the phone system 520 may transcode calls into VoIP, or receive (and possibly transcode) VoIP streams directly from third parties (e.g., telecommunication companies). In those embodiments, events would originate not from the cards, but transparently from an IP network.

The world servers 516 can associate each authenticated VoIP connection with a client connection, if existent. The world servers 516 can associate each authenticated PBX connection with a client connection, if existent.

The server system 510 can provide the same virtual representation to different kinds of client devices 502, possibly with different visual representations (e.g. 3D, isometric, and textual), whereby users of those different client devices 502 can still interact with each other. For devices that are enabled to run text sessions, such as Telnet sessions, a user could establish a text session to receive information, questions and options, and also to enter commands. For textual devices, a written description of a virtual environment could be provided.

The phone system 520 can also allow users of phones to control objects in a virtual environment. A user without a client device and with only a phone can experience sounds of the virtual environment as well as speak with other users (having or not having client devices 502), even if that user cannot see sights of the virtual environment. The phone system 520 can accept phone signals (e.g., DTMF, voice commands) from phones to control the actions of their corresponding representation in the virtual environment. The phone system 520 could also receive SMS or MMS to control these actions.

A phone 504 generates signals for selecting and controlling objects in the virtual representation, and the phone system 520 translates the signals and informs the server system to take action, such as changing the state of an object. As examples, the signals may be dial tone (DTMF) signals, voice signals, or some other type of phone signal. Consider a touch tone phone. Certain buttons on the phone can correspond to commands. A user with a touch phone or DTMF-enabled VoIP phone can execute a command by entering that command using DTMF tones. The telephony server 522 detects the (in-band) DTMF tones and converts them into (out-of-band) control signals which are passed to the world server 516. Each command can be supplied with one or more arguments. An argument could be a phone number or other number sequence. In some embodiments, voice commands could be interpreted and used.

The server system 510 can also include a server 517 for providing an audio description of a virtual environment. For example, a virtual environment can be described to a user from the perspective of the user's avatar. Objects that are closer to the user's avatar might be described in greater detail. The description may include or leave out detail to keep the overall length of the description approximately constant. The user can request more detailed descriptions of certain objects, upon which additional details are revealed. The server system 510 can also generate an audio description of options in response to a command. The phone system 520 mixes the audio description (if any) and other audio, and supplies the mixed sound data to the user's phone.

The sound system 526 can play sound clips, such as sounds in the virtual environment. The sound clips are synchronized with state changes of the objects in the virtual environment. The sound system 526 starts and stops the sound clips at the state transition start and stop times indicated by the world server 516.

The sound system 526 can mix sounds of the virtual environment with audio from the phones 504. Sound mixing is not limited to any particular sound model. The phone system 520 may receive a list of patches, sets of coefficients, and goes through the list.

The VE server system 510 may also include one or more servers that offer additional services. For example, one or more web containers 518 might be used to implement servlet and JavaServer Pages (JSP) specifications to provide an environment for Java code to run in cooperation with the web servers 512.

All servers in the system 500 can be run on the same machine, or distributed over different machines. Communication may be performed using remote invocation. For example, an HTTP or HTTPS-based protocol (e.g. SOAP) can be used by the server(s) and network-connected devices to transport the clients and communicate with the clients.

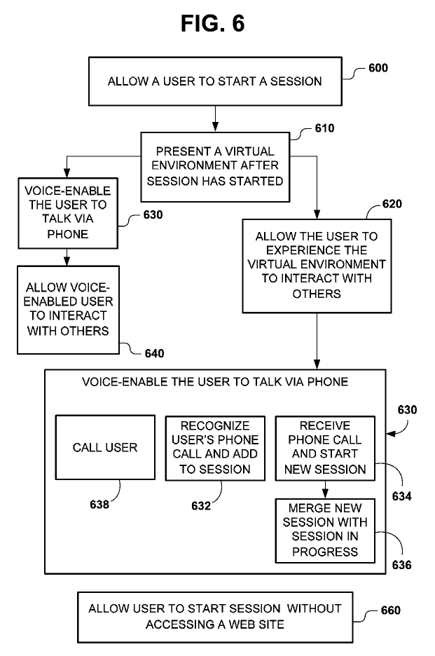

Reference is now made to FIG. 6, which illustrates an example of using the system 500. At block 600, a user is allowed to start a session. For example, using a web browser, a user enters a web site, and logs into the system 500. The provider of the service starts the session.

After the session is started, a virtual environment is presented to the user (block 610). If, for example, the service provider runs a web site, a web browser can download and display a virtual environment to the user.

A user can control its representative object to move around a virtual environment to experience the different sights and sounds that the virtual environment provides (block 620). For instance, a representative object could turn on a jukebox and select songs from a playlist. The jukebox would play the selected songs. Users could also drag and drop songs from a shared or local file folder onto the jukebox to have the songs uploaded and played.

A user can also move its representative object around a virtual environment to interact with other users represented in the virtual environment (block 640). The user's representative object may be moved by clicking on a location in the virtual environment, pressing a key on a keyboard, pressing a key on a telephone, entering text, entering a voice command, etc.

There are various ways in which the user can interact with other users in the virtual environment. One way is by wandering around the virtual environment and hearing conversations that are already in progress. As the user moves its representative object around the virtual environment, that user can hear voices and other sounds.

The user can then participate in a conversation or otherwise interact with others (block 640) by becoming voice-enabled via phone (block 630). Becoming voice-enabled allows the user to speak with others who are voice-enabled. For example, the user wants to have a teleconference using a phone. To enter into a teleconference, the user uses the phone to call the communications system. Using a traditional telephone, the user can call the virtual environment that he is in (e.g., by calling a unique phone number, or by calling a general number and entering additional data such as user ID and PIN, via DTMF). Using a VoIP phone, a user could call a virtual environment by calling its unique VoIP address.

The service provider can join the phone call with the session in progress if it can recognize the user's phone number (block 632). If the service provider cannot recognize the user's phone number, the user starts a new session via the phone (block 634), the user identifies himself (e.g., by entering additional data such as a user ID and PIN via DTMF) and then the service provider merges the new phone session with the session already in progress (block 636). Instead of the user calling the service provider, the user can request the service provider to call the user (block 638).

Once voice-enabled (block 630), the user can use a phone to talk to others who are voice-enabled. Once voice-enabled (block 630), the user remains voice-enabled until the user discontinues the call (e.g., hangs up the phone).

In some embodiments, the system 500 allows a user to log into the teleconferencing service and enter into a conversation without accessing the web site (block 660). A user might only have access to a touch-tone telephone or other phone 504 that can't display a virtual environment. Consider a traditional telephone. With only the telephone, the user can call a telephone number and connect to the service provider. The service provider can then add the user's representative object to the virtual environment. Via telephone signals (e.g., DTMF, voice control), the user can move its representative object about the virtual environment, listen to other conversations, meet other people and experience the sounds (but not sights) of the virtual environment. Although the user cannot see its representative objects, others viewing the virtual environment can see the user's representative object.

More than one virtual environment may be hosted at any given time. If more than one virtual reality environment is available to a user, the user can move into and out of the different virtual environments, and thereby interact with even more people. Each of the virtual environments can be uniquely addressable via an Internet address or a unique phone number. The service provider can then place each user directly into the selected target virtual environment. Users can reserve and enter private virtual environments to hold private conversations. Users can also reserve and enter private areas of public environments to hold private conversations. A web browser or other graphical user interface could include a sidebar, a browser extension or other means for indicating different environments that are available to a user. The sidebar allows a user to move into and out of different virtual environments, and to reserve and enter private areas of a virtual environment.

Communication between users is not limited only to conversations via phones. Communication can occur in other ways. Examples include, without limitation, video streams, text chat messages, instant messenger messages, avatar gestures or moves, mood expressions, emoticons, and web pages.

The state of a virtual environment may be persistent in that it continues to exist throughout many user sessions and it continues to exist through the actions of different users. This allows a virtual environment to be modified by one user, and the modifications observed by others. For example, graffiti can be written on walls, a light switch in a virtual reality environment could be switched on and off, etc., as a way of signaling to another user.

Objects in the virtual environment can be added, removed, moved and modified by a user as a way of signaling to another user. Examples of objects include sound sources (e.g., music boxes, bubbling fish tanks), data objects (e.g., a modifiable book with text and pictures), visualized music objects, etc.

Communication between users may be performed by sharing certain objects. The persistent state also allows “things” to be put on top of each other. A file can be dropped onto a user or dropped onto the floor as a way of sharing the file with the user. A music or sound file could be dropped on a jukebox. A picture or video on a projector device to trigger playback/display. A multimedia sample (e.g., an audio clip or video clip containing a message) could be “pinned” to a whiteboard.

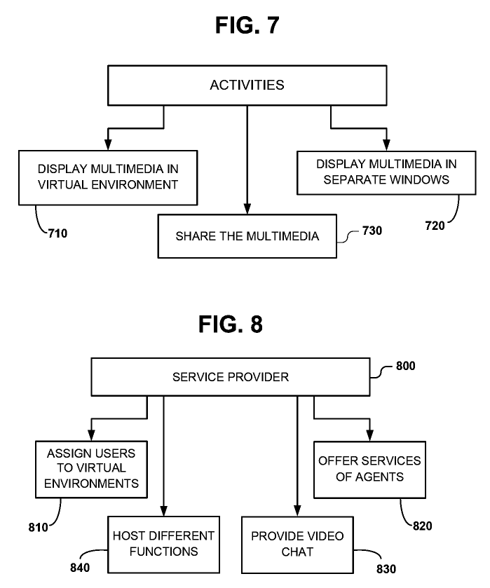

Reference is now made to FIG. 7, which illustrates different activities that may be facilitated by a service provider. Multimedia sources could be displayed (e.g., viewed, listened to) from within a virtual environment (block 710). For example, a video clip could be viewed on a screen inside a virtual environment. Sound could be played from within a virtual environment.

Multimedia sources could be viewed in separate popup windows (block 720). For example, another instance of a web browser is opened, and a video clip is played in it.

The virtual environment facilitates sharing the multimedia (block 730). Multiple users can share a media presentation (e.g., view it, edit it, browse, listen to it), and, at the same time, discuss the presentation via phones. In some embodiments, one of the users can control the presentation of the multimedia. This feature allows all of the browsers to be synchronized, so all users can watch a presentation at the same time. In other embodiments, each user has control over the presentation, whereas the browsers are not synchronized.

A multimedia connection can be shared in a variety of ways. One user can share a media connection with another user by drag-and-dropping a multimedia representation onto the other user's avatar, or by causing its avatar to hand the multimedia representation to the other user user's avatar.

As a first example, a first user's avatar drops a video file, photo or document on a second user's avatar. Both the first and second user then watch the video in a browser or media player or on a virtual video screen in the virtual environment, while seamlessly discussing it via teleconferencing in the virtual environment.

As a second example, a first user's avatar drops a URL on a second user's avatar. A web browser for each user opens, and downloads content at the URL. The first and second users can then co-browse, while discussing the content over their phones.

As a third example, a user presents something to the surrounding avatars. All users within range get to see the presentation (first, however, they might be asked whether they want to see the presentation).

Reference is now made to FIG. 8. The service provider 800 could provide other services. One service is automatically assigning a user to certain virtual environments based on a characteristic of the user (block 810). The characteristic may be a parameter in the user's profile, or an interest of the user, or a mood of the user, or some other characteristic.

A user may have multiple profiles. Each profile represents a different aspect of the user. Different profiles give the user access to certain virtual environments. A user can switch between profiles during a session.

In some embodiments, user profiles can be made public, so they can be viewed by others. For instance, a first user might wander around a virtual environment, looking for people to meet. The first user could learn about a second user by clicking on the avatar of that second user. In response, the second user's profile would be displayed to the first user. If the profile does not disclose the user's real name and phone number, the second user stays anonymous.

Another service is providing agents (e.g. operators, security, experts) that offer services to those in the virtual environment (block 820). As a first example, users might converse while watching a movie, while an agent finds information about the cast. As a second example, a user chats with another person, and the person requests an agent to look up something with a search engine. As a third example, an agent identifies lonely participants that seem to match and introduces them to each other.

Another service is providing a video chat service (block 830). For instance, the service provider might receive web camera data from different users, and associate the web camera data with the different users such that a user's web camera data can be viewed by certain other users. The size or quality of the displayed camera data could be a function of closeness to the viewed user's avatar or other object.

Yet another service is hosting different functions in different virtual environments (block 840). Examples of different functions include, without limitation, social networking, business conferencing, business-to-business services, business-to-customers services, events, trade fairs, conferences, work and recreation places, virtual stores, promoting gifts, on-line gambling and casinos, virtual game and entertainment shows, virtual schools and universities, on-line teaching, tutoring sessions, karaoke, pluggable (team) games, casinos, award-based contests, clubs, concerts, virtual galleries, museums, and demonstrations or any scenario available in real life. A virtual environment could even be used to host a television show or movie.

1. A method of providing a service comprising:
providing a network-accessible virtual environment including objects that represent users of the service;
allowing the users to control their representative objects in the virtual environment to personally interact with other users represented in the virtual environment and also to become voice-enabled; and
enabling those users who are voice-enabled to speak with other voice-enabled users via phones.

2. The method of claim 1, wherein the users control their representative objects via client devices; and wherein allowing the users to control their objects includes receiving commands from the client devices and moving the representative objects in response to the commands.

3. The method of claim 1, wherein the users are allowed to control their representative objects via the Internet; and wherein those users who are voice-enabled are enabled to speak with each other via a public switched telephone network.

4. The method of claim 1, further comprising interacting with the virtual environment to control audio characteristics in the virtual environment.

5. The method of claim 1, wherein objects in the virtual environment have audio ranges, whereby the volume of the sound data is also controlled according to the audio ranges.

6. The method of claim 5, wherein users interact as a function of how close together they are.

7. The method of claim 6, wherein closeness between two users is measured as a distance between web pages concurrently viewed by those two users.

8. The method of claim 6, wherein closeness between two users is measured as a distance between two coordinates on a web page that is concurrently viewed by those two users.

9. The method of claim 1, wherein the users are represented by avatars;
and wherein volume of sound data between two users is a function of relative orientation of their avatars.

10. The method of claim 1, further comprising allowing certain users to personally interact with other users in the virtual environment without seeing the virtual environment.

11. The method of claim 1, further comprising calling a user at the user's request so the user can be voice-enabled in the virtual environment.

12. The method of claim 1, wherein when a user calls another not represented in the virtual environment, a representative object of said another is added to the virtual environment.

13. The method of claim 1, wherein multiple virtual environments are provided; and wherein a user can move into and out of different virtual environments.

14. The method of claim 1, wherein communication is also performed by shared, modifiable objects.

15. The method of claim 1, further comprising allowing users to communicate through intuitive actions of their avatars.

16. The method of claim 1, wherein users share a multimedia connection by each viewing a window that displays the multimedia connection and, at the same time, discussing the displayed multimedia via phones.

17. The method of claim 1, wherein users share multimedia by co-browsing.

18. The method of claim 1, wherein a user shares a multimedia source with another user by drag-and-dropping a multimedia representation proximate the other user's representative object.

19. The method of claim 1, wherein additional virtual environments are available to a user, wherein the user is instead assigned to one of the additional virtual environments based on a characteristic of the user.

20. The method of claim 1, wherein a user has multiple profiles, each profile representing a different aspect of the user, wherein the user can switch between multiple profiles.

21. A system comprising:
means for providing a network-accessible virtual environment including objects that represents system users;
means for allowing the users to control their representative objects in the virtual environment to personally interact with other users represented in the virtual environment and also to become voice-enabled; and
means for enabling those users who are voice-enabled to speak with other voice-enabled users via phones.

22. A system comprising:
a server system for providing a virtual environment including objects that represents users of the system, the server system allowing the users to control their representative objects in the virtual environment to interact with other users represented in the virtual environment; and
a phone system for enabling those users who are voice-enabled to speak with other voice-enabled users via phones.

23. The system of claim 22, wherein the server system is web-based; and
wherein the server system receives commands from client to devices to control objects in the virtual environment; and wherein the phone system enables at least some users to speak via a public switched telephone network.
